(19) United States
(12) Patent Application Publication
(10) Pub. No.: US 2012/0129128 A1
(43) Pub. Date: May 24, 2012

(54) Vacuum Level Control Valve For A Dental Vacuum System

(75) Inventor: Kevin CARPENTER, Orange Beach, AL (US)

(73) Assignee: RAMVAC DENTAL PRODUCTS, INC., Wynnewood, PA (US)

(21) Appl. No.: 12/948,845

(22) Filed: Nov. 18, 2010

(51) Int. Cl. A61C 17/12

(52) U.S. Cl. 433/95

(57) ABSTRACT

A control valve for a dental vacuum system includes a housing having a first end, a second end and a sidewall therebetween, which define a cavity of the housing. An imaginary central longitudinal axis extends from the first end to the second end and generally parallel to the sidewall. A first opening in the sidewall of the housing is operatively connected to a vacuum control volume and a pair of opposing second openings in the sidewall are spaced-apart from the first opening along the imaginary central longitudinal axis. A biasing member and a plunger valve are located within the cavity of the housing. The plunger valve is movable along the imaginary central longitudinal axis between a first position that blocks at least a portion of a flow of air through the housing and a second position that substantially permits the flow of air through the housing and to a vacuum pump.

### BACKGROUND OF THE INVENTION

The present invention relates generally to a system for maintaining a vacuum level and, more particularly, to a control valve for a dental vacuum system.

Dentists and dental hygienists commonly employ a vacuum system to evacuate maximum airflow at an ideal vacuum level from a dental tool without creating traumatic suction pressure that could harm a patients' delicate oral tissue. A conventional vacuum system may be located at the dentist's office and is capable of evacuating airflow from a dentist's tool in one or more remote patient rooms. These systems generally include a control valve to maintain a desired vacuum level.

A conventional vacuum level control valve is typically positioned downstream of an air filter. A surface or face of the valve is open or exposed to allow atmospheric air to pass therethrough. In operation, atmospheric air enters a hole located in a spring seat on a base plate of the valve and through the air filter. In conventional control valves, the direction of initial air travel is in the axial direction of valve travel (i.e., parallel to valve travel or along a longitudinal axis of the valve).

Conventional vacuum level control valves do not adequately maintain vacuum levels. Specifically, conventional valves have a certain cracking pressure based on spring force. Once the cracking pressure is reached, the valve opens and the system's flow rate dictates the valve's position. Valve oscillations are undesirable in conventional vacuum systems without sufficient damping.

Therefore, it would be desirable to create a vacuum system that overcomes the above-described disadvantage by utilizing a control valve wherein the valve position is controlled by a separate control volume from that which supplies the vacuum level to the system. More specifically, it would be desirable to create a vacuum level control valve wherein the flow of air through the valve to a vacuum pump is perpendicular to the axial direction of valve travel, thus eliminating velocity forces in the axial direction. The present invention accomplishes these objectives.

### BRIEF SUMMARY OF THE INVENTION

Briefly stated, the present invention is directed to a control valve for a dental vacuum system that includes a housing having a first end, an opposing second end and a sidewall therebetween. The combined first end, second end and sidewall generally define a cavity of the housing. An imaginary central longitudinal axis of the control valve extends from the first end to the second end of the housing and generally parallel to the sidewall. A first opening in the sidewall of the housing is operatively connected to a vacuum control volume. The housing also includes a pair of opposing second openings in the sidewall thereof. The second openings are spaced-apart from the first opening along the imaginary central longitudinal axis. A biasing member and a plunger valve are located within the cavity of the housing. The plunger valve is movable along the imaginary central longitudinal axis between a first position that blocks at least a portion of a flow of air through the housing and a second position that substantially permits the flow of air through the housing and to a vacuum pump.

### BRIEF DESCRIPTION OF THE SEVERAL VIEWS OF THE DRAWINGS

The following detailed description of the invention will be better understood when read in conjunction with the appended drawings. For the purpose of illustrating the invention, there is shown in the drawings an embodiment which is presently preferred. It should be understood, however, that the invention is not limited to the precise arrangements and instrumentalities shown.

In the drawings:

FIG. 1 is a schematic diagram of a vacuum system and control valve according to a preferred embodiment of the present invention, wherein a portion of the control valve is shown in cross-section;

FIG. 2 is an exploded top perspective view of the control valve shown in FIG. 1; and

FIG. 3 is an elevation view of the control valve shown in FIG. 2, wherein a portion of the control valve is shown in cross-section.

### DETAILED DESCRIPTION OF THE INVENTION

Certain terminology is used in the following description for convenience only and is not limiting. The words “upwardly,” “downwardly,” “lower” and “upper” designate directions in the drawings to which reference is made. Unless specifically set forth herein, the terms “a,” “an” and “the” are not limited to one element but instead should be read as meaning “at least one.” The terminology includes the words noted above, derivatives thereof and words of similar import.

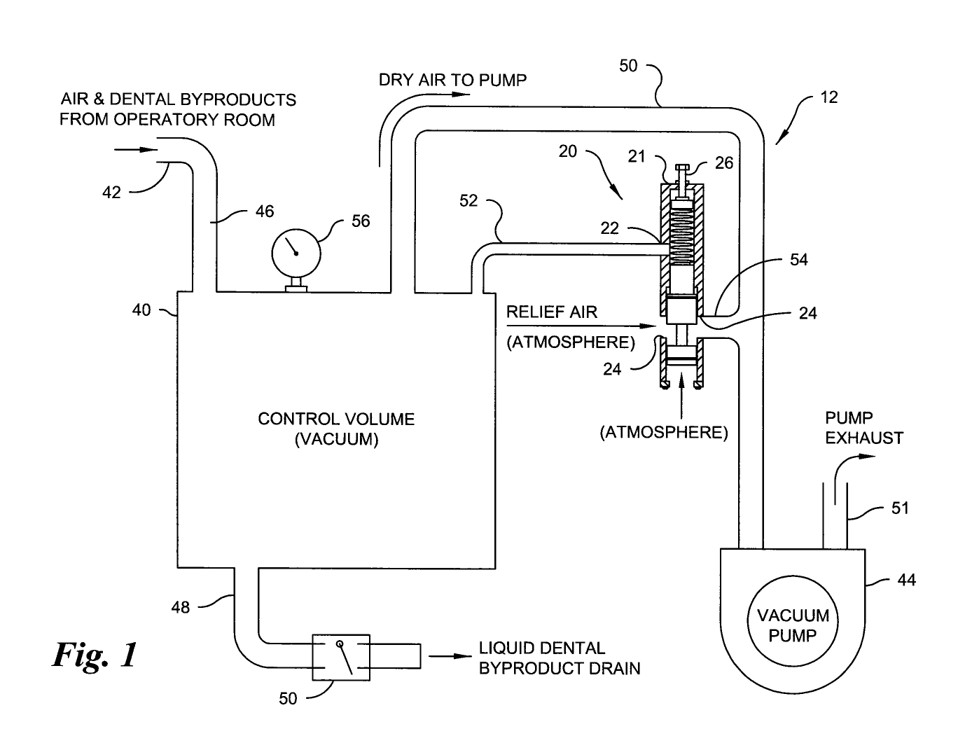

Referring to the drawings in detail, wherein like numerals indicate like elements throughout, there is shown in FIGS. 1-3 a vacuum system, generally designated 12, including a control valve, generally designated 20, according to a preferred embodiment of the present invention. The control valve 20 has specific applicability to vacuum systems 12 used at a dentist's office, for example, but the present invention is not so limited. For example, the control valve 20 may be employed or beneficial in any environment that utilizes a vacuum or regulates a vacuum level.

Referring to specifically to FIG. 1, the system 12 includes a vacuum control volume 40, which preferably operatively connects an operatory room 42, such as a dentist's office or examining room, to a vacuum pump 44. In the present embodiment, a dental tool (not shown), such as a suction device, at a dentist's examining chair is located within the operatory room 42. The system 12 and control valve 20 of the present invention allow the dentist to evacuate maximum airflow at an ideal vacuum level to the dental tool without creating traumatic suction pressure that could harm a patients' tissue.

The vacuum pump 44 preferably operates at a constant speed or rate to continuously maintain a vacuum within the vacuum control volume 40. The term “vacuum” as used herein is defined as a particular level or range of air pressure and is measured in terms of inches of mercury (inHg), wherein zero inches of mercury (0 inHg) indicates the level of atmospheric air and thirty inches of mercury (30 inHg) indicates a pure or absolute vacuum. As described in further detail below, the vacuum control volume 40 functions as an air and liquid separation tank, which physically separates the combination of air and liquid, such as a patient's saliva, that is drawn by the dentist's tool.

As schematically shown in FIG. 1, the vacuum control volume 40 is preferably connected to the operatory room 42 by a first conduit or passageway 46. The vacuum control volume 40 preferably includes a separate second conduit or passageway 48 having a check valve 50 therein for regulating the flow of air and/or liquid through the second conduit 48. The second conduit 48 preferably functions as a liquid dental byproduct drain. A separate third conduit or passageway 50 preferably directly connects the vacuum pump 44 to the vacuum control volume 40. Thus, the third conduit 50 functions as an air inlet to the vacuum pump 44. An air outlet 51 of the vacuum pump 44 expels and/or releases air out of the vacuum pump 44. A separate fourth conduit or passageway 52 preferably connects the vacuum control volume 40 directly to the control valve 20, and a separate fifth conduit or passageway 54 preferably connects the control valve 20 directly to the third conduit 50, as described in detail below. It is understood that the size, shape and orientation of each conduit 46, 48, 50, 51, 52, 54 is not limited to configuration shown in FIG. 1. An indicator gauge 56 is preferably located on an exterior portion of the vacuum control volume 40 and displays the vacuum level within the vacuum control volume 40.

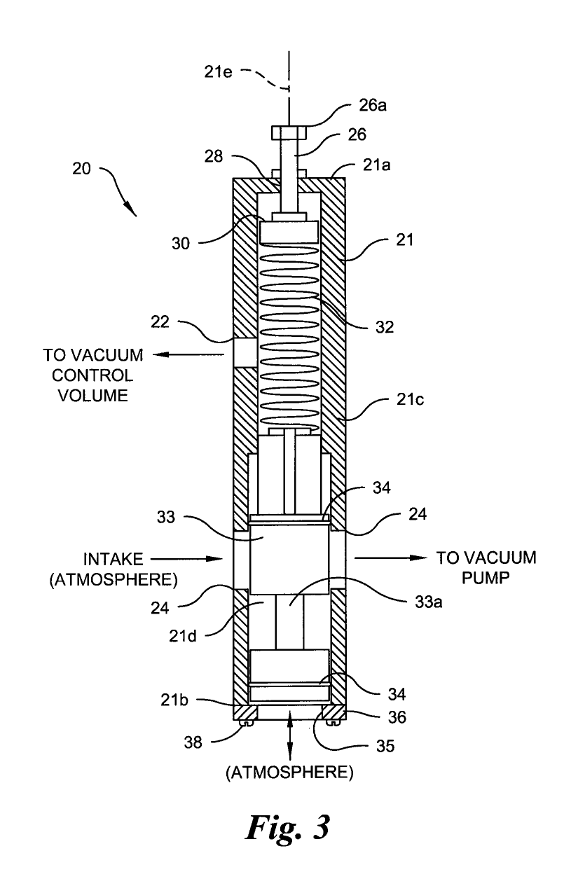

Referring to FIGS. 1-3, the control valve 20 preferably includes a housing 21 having a generally closed first or upper end 21a, an opposing generally open second or lower end 21b and a sidewall 21c therebetween. The combined first end 21a, second end 21b and sidewall 21c generally defining a generally cylindrical cavity 21d (FIG. 3) within the housing 21. An imaginary central longitudinal axis 21e (shown in phantom in FIG. 3) of the control valve 20 extends preferably at least from the first end 21a to the second end 21b of the housing 21 and generally, if not exactly, parallel to the sidewall 21c. The cavity 21d preferably includes a symmetrical, but not uniform, cross-section along the imaginary central longitudinal axis 21e. The housing 21 preferably includes four spaced-apart, generally flat or planar sidewalls 21c, such that the housing 21 is rectangular or square in shape in a longitudinal cross-section thereof, but the shape of the housing 21 is not so limited. For example, the housing 21 may be circular or ovular in longitudinal cross-section, such that the housing 21 includes a single, arcuate sidewall 21c that extends around the entire perimeter thereof.

In the preferred embodiment, one portion of the sidewall 21c of the housing 21 includes a first opening 22 that is operatively connected to the vacuum control volume 40 by the fourth conduit 52. The first opening 22 preferably extends from the cavity 21d or an interior of the housing 21 through the sidewall 21c to an exterior of the housing 21. In the preferred embodiment, the first opening 22 is located along the imaginary central longitudinal axis 21e closer to the first end 21a of the housing 21 than the second end 21b of the housing 21. However, the first opening 22 is not limited to a particular position, location or arrangement. The first opening 22 is preferably directly connected to the fourth conduit 52.

Further, two preferably directly opposing portions of the sidewall 21c of the housing 21 preferably include a second opening 24 that allows atmospheric (relief) air to pass through the housing 21 and to the vacuum pump 44. Thus, the control valve 20 preferably includes two second openings 24 that are located at the same point or position along the imaginary central longitudinal axis 21e. Each second opening 24 is preferably spaced-apart along the imaginary central longitudinal axis 21e from the first opening 22, and each second opening 24 is preferably located along the imaginary central longitudinal axis 21e closer to the second end 21b of the housing 21 than the first end 21a of the housing 21. However, the arrangement of the second openings 24 and the first opening 22 is not limited to the above-described orientation, as it is possible that each of the second openings 24 could be positioned closer to the first end 21a of the housing 21 than the first opening 22. Further, each second opening 24 preferably has a larger diameter and cross-sectional area than the first opening 22.

A biasing member 32, such as a conventional coil spring, and a plunger valve or piston 33 are preferably located within the cavity 21d or the interior of the housing 21. A first or upper end of the biasing member 32 engages a lower surface of a spring seat or plate 30 enclosed within the cavity 21d. An opposite second or lower end of the biasing member 32 engages and/or surrounds at least a portion of a first or upper end of the plunger valve 33. As described in further detail below, the plunger valve 33 is preferably movable along the imaginary central longitudinal axis 21e between a lower first position (FIG. 3) that blocks at least a portion of a flow of atmospheric air through the housing 21 (by way of the opposed second openings 24) and an upper second position (FIG. 1) that substantially permits the flow of atmospheric air through the housing 21 (by way of the opposed second openings 24) and to a vacuum pump 44. It is preferred that when the plunger valve 33 is in the lower first position (FIG. 3), the plunger valve 33 completely blocks the flow of atmospheric air through the second openings 24 and the housing 21, however the present invention is not limited to this arrangement, as the lower first position may allow a relatively low flow of atmospheric air through the housing 21 by way of the opposed second openings 24.

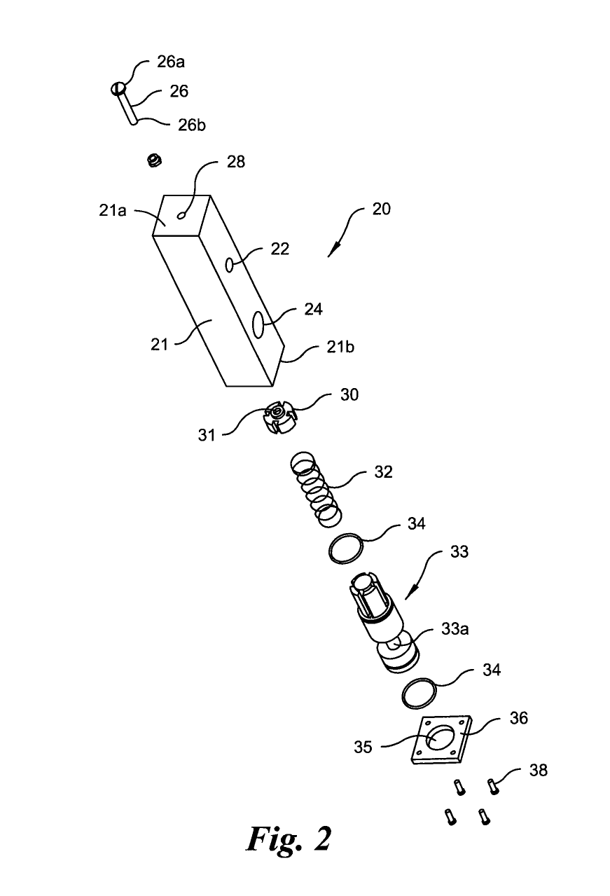

An adjustment screw 26 having screw threads (not shown) preferably extends through an aperture 28 positioned generally at the center of the first end 21a of the housing 21. The adjustment screw 26 is preferably movable along the imaginary central longitudinal axis 21e and removable from the aperture 28. When the adjustment screw 26 is positioned within the aperture 28, the first end 21a of the housing 21 is generally closed, such that air is not permitted to flow through the first end 21a of the housing 21. A first or upper end 26a of the adjustment screw 26 includes a gripping portion or enlarged screw head and a second or lower end 26b of the adjustment screw 26 is sized and shaped to fit within and engage a seat or recess 31 (FIG. 2) on a top surface of the spring seat 30. Rotation of the adjustment screw 26 moves the spring seat 30 along the imaginary central longitudinal axis 21e within the cavity 21d of the housing 21 to adjust the location of the upper end of the spring 32 and, therefore, adjust a force exerted by the spring 32, as described in detail below.

In the preferred embodiment, the plunger valve 33 preferably includes a reduced diameter portion 33a spaced-apart from each end of the plunger valve 33. The plunger valve 33 is preferably at least generally cylindrical in shape, but may also be rectangular in shape depending upon the shape of the cavity 21d of the housing 21. Thus, it is preferred that a diameter of a cross-section of the reduced diameter portion 33a is less than a diameter of a cross-section of either end of the plunger valve 33. It is preferred that alignment of the reduced diameter portion 33a of the plunger valve 33 and the pair of second openings 24 along the imaginary central longitudinal axis 21e permits the flow of atmospheric air through the housing 21 and to the vacuum pump 44 when the plunger valve 33 is in the second position (FIG. 1). The plunger valve 33 may include at least one and more preferably two spaced-apart damping seals or O-rings 34 located within seal glands in the plunger valve 33 (one above and one below the reduced diameter portion 33a of the plunger valve 33). Each damping seal 34 preferably engages a portion of an interior surface of the housing 21. The at least one damping seal 34 preferably inhibits oscillation of the plunger valve 33 within the housing 21. However, the control valve 20 is not limited to the inclusion of the one or more damping seals 34. The biasing member 32 creates a force that biases the plunger valve 33 downwardly to the first position (FIG. 3).

A bottom plate 36 is preferably fastened to the bottom end 21b of the housing 21 by at least one fastener 38 that extends into the housing 21. The bottom plate 36 generally encloses the dampening seals 34, the plunger valve 33, biasing member 32 and spring seat 30 within the cavity 21d housing 21. The bottom plate 36 preferably includes a opening 35 generally centrally located therein. The opening 35 preferably exposes the bottom surface of the plunger valve 33 to atmospheric air. The opening 35 in the bottom plate 36 preferably has a larger diameter than the aperture 28 in the first end 21a of the housing 21.

In operation, the vacuum pump 44 preferably continuously operates to maintain the vacuum control volume 40 at a desired vacuum level, such as between zero inches of mercury (atmospheric air) and thirty inches of mercury (considered a pure vacuum). During normal operation of the dentist's tool (i.e., when atmospheric air flow through the dentist's tool is not block), atmospheric air and liquid flow into the vacuum control volume 40 through the first conduit 46. The liquid then preferably flows out of the vacuum control volume 40 through the second conduit 48. The air preferably flows from the vacuum control volume 40 through the third conduit 50 and out of the system 12 through the vacuum pump 44. In this normal operation of the dentist's tool, the plunger valve 33 is in the first position (FIG. 3), such that the plunger valve 33 completely or almost completely blocks the flow of air from one of the second openings 24 to the other of the second openings 24. In other words, the plunger valve 33 is in the first position (FIG. 3) when a pressure difference between atmospheric air and the vacuum control volume 40 is insufficient to overcome the combined force of the biasing member 32 and dampening seals 34.

However, if the dentist's tool is at least partially covered or the flow of air through and into the dentist's tool is otherwise at least partially blocked, the flow of atmospheric air into the vacuum control volume 40 ceases or is at least reduced. At this point, the vacuum quickly approaches an undesirable level within the vacuum control volume 40 (such as approaching pure vacuum). As mentioned above, a pure vacuum within the vacuum control volume 40 can be dangerous, as it creates strong pressure on a patient's oral tissue. As the vacuum level beings to approach a pure vacuum, a force caused by the atmospheric air acting against the bottom of the plunger 33, through the central opening 35 in the bottom plate 36, begins to overcome the combined spring 32 and dampening seals 34 forces holding the plunger valve 33 in the first position (FIG. 3). As the magnitude of the force created by atmospheric air upwardly on the bottom of the plunger valve 33 becomes greater than the magnitude of the combined force of the spring 32 and the dampening seals 34 acting downwardly, the plunger valve 33 begins to move upwardly toward or to the second position (FIG. 1), such that relief atmospheric air flows through the second openings 24 and passed or around the reduced diameter portion 33a of the plunger valve 33 and to the vacuum pump 44 to reduce the vacuum level in the control volume 40. In other words, the plunger valve 33 is in the second position (FIG. 1) when the pressure of atmospheric air is greater than that of the vacuum control volume 40 sufficient to overcome the combined force of the biasing member 32 and dampening seals 34. In addition or alternatively, as the vacuum level begins to approach a pure vacuum in the vacuum control volume 40, the negative pressure helps to pull the plunger valve 33 upwardly to open the control valve 20 to reduce the vacuum in the vacuum control volume 40.

The above operation reduces the vacuum level within the vacuum control volume 40 until the dentist's tool once again allows atmospheric air into the vacuum control volume 40 (i.e., when the dentist's tool is no longer blocked). At this point, the magnitude of the combined spring 32 and dampening seals 34 downward force within the control valve 20 is greater than the magnitude of the force of atmospheric air against the bottom of the plunger valve 33, such that the plunger valve 33 begins to move downwardly to again block the second openings 24 (i.e., to the first position). Further, the adjustment screw 26 allows a user to adjust the vacuum level within the vacuum control volume 40 by varying the position of the biasing member 32 to vary the downward force exerted on the plunger valve 33. Further, atmospheric air is prevented from flowing through the central opening 35 in the bottom plate 36 to either second opening 24 at all times by the lower portion of the plunger valve 33.

Thus, in the present invention, the valve position is controlled by a separate control volume (i.e., the control volume is under vacuum, see the fourth conduit 52 of FIG. 1) to which the system's vacuum level is applied (i.e., the vacuum control volume 44). The flow through the control valve 20 to the vacuum pump 44 is perpendicular to the axial direction of plunger valve 33 travel (i.e., parallel to the imaginary central longitudinal axis 21e), thus eliminating velocity forces in the axial direction. In other words, the design of the present invention effectively separates the vacuum control volume 40 from the flow control volume, allowing the system's vacuum level to dictate valve position. With turbulent forces minimized in the axial direction of the control valve 20, any minor oscillations are damped by the internal frictional forces acting on the plunger valve 33 by the dampening seals 34. The improved control of the present invention equates to improved airflow characteristics of the system across a wider range of vacuum levels.

From the foregoing, it can be seen that the present invention comprises an apparatus and method for controlling vacuum levels. It will be appreciated by those skilled in the art that changes could be made to the embodiment described above without departing from the broad inventive concepts thereof. It is understood, therefore, that this invention is not limited to the particular embodiment disclosed, but it is intended to cover all modifications within the spirit and scope of the present invention as defined by the appended claims.

I/We claim:

1. A control valve for a dental vacuum system comprising:
a housing having a first end, an opposing second end and a sidewall therebetween, the combined first end, second end and sidewall generally defining a cavity therein, an imaginary central longitudinal axis of the control valve extending from the first end to the second end of the housing and generally parallel to the sidewall;
a first opening in the sidewall of the housing operatively connected to a vacuum control volume;
a pair of opposing second openings in the sidewall of the housing, the second openings being spaced-apart from the first opening along the imaginary central longitudinal axis; and
a biasing member and a plunger valve within the cavity of the housing, the plunger valve being movable along the imaginary central longitudinal axis between a first position that blocks at least a portion of a flow of air through the housing and a second position that substantially permits the flow of air through the housing and to a vacuum pump.

2. The control valve according to claim 1 wherein the plunger valve includes a reduced diameter portion, and wherein alignment of the reduced diameter portion of the plunger valve and the pair of second openings along the imaginary central longitudinal axis permits the flow of air through the housing and to the vacuum pump.

3. The control valve according to claim 2 wherein the plunger valve includes two spaced-apart damping seals that surround the reduced diameter portion of the plunger valve, each damping seal engaging a portion of an interior of the housing.

4. The control valve according to claim 2 further comprising:
a plate removably fastened to the second end of the housing by at least one fastener, the plate generally enclosing the dampening seals, the plunger valve, and the biasing member within the housing.

5. The control valve according to claim 4 further comprising:
an adjustment screw extending through an aperture in the first end of the housing, one end of the adjustment screw connected to a spring seat, wherein rotation of the adjustment screw moves the spring seat along the imaginary central longitudinal axis within the cavity of the housing.

6. The control valve to according to claim 5 wherein the biasing member is a coil spring and is positioned between the spring seat and one end of the plunger valve.

7. The control valve according to claim 6 wherein at least a portion of the coil spring surrounds at least a portion of the plunger valve.

8. The control valve according to claim 5 further comprising an orifice in the plate, the orifice having a larger area than the aperture in the first end of the housing.

9. The control valve according to claim 1 wherein the housing is rectangular in shape in a longitudinal cross-section thereof.

10. The control valve according to claim 1 wherein each second opening has a larger area than the first opening.

11. The control valve according to claim 1 wherein air flow through the control valve to the vacuum pump is perpendicular to an axial direction of travel of the plunger valve.

12. The control valve according to claim 1 wherein the first opening is located between the first end of the housing and the pair of second openings along the imaginary central longitudinal axis.

13. The control valve according to claim 1 wherein the first position of the plunger valve completely blocks the flow of air through the housing.

14. The control valve according to claim 13 wherein the plunger valve is in the first position during a period when the pressure difference between atmospheric air and the vacuum control volume is insufficient to overcome a combined force of the biasing member and dampening seals, and the plunger valve is in the second position when the pressure of atmospheric air is greater than that of the vacuum control volume sufficient to overcome the combined force of the biasing member and dampening seals.
